(19) United States
(12) Patent Application Publication
(10) Pub. No.: US 2022/0098488 A1
(43) Pub. Date: Mar. 31, 2022

(54) HALOGEN-FREE INORGANIC FLAME RETARDANT MATERIAL AND PREPARATION METHOD AND APPLICATION THEREOF

(71) Applicant: JIANGSU UNIVERSITY, Zhenjiang, Jiangsu (CN)

(72) Inventors: Zhizhong YUAN, Zhenjiang, Jiangsu (CN); Rui LUO, Zhenjiang, Jiangsu (CN); Guanglei LIU, Zhenjiang, Jiangsu (CN); Fuyang CAO, Zhenjiang, Jiangsu (CN); Wenlong MA, Zhenjiang, Jiangsu (CN); Yi SONG, Zhenjiang, Jiangsu (CN); Junling LIU, Zhenjiang, Jiangsu (CN); Haitao XU, Zhenjiang, Jiangsu (CN)

(73) Assignee: JIANGSU UNIVERSITY, Zhenjiang, Jiangsu (CN)

(21) Appl. No.: 17/274,400

(22) PCT Filed: May 8, 2020
(86) PCT No.: PCT/CN2020/089169

§ 371 Date: Mar. 8, 2021

(30) Foreign Application Priority Data
Mar. 26, 2020 (CN) 202010222296.7

(51) Int. Cl. C09K 21/02

(52) U.S. Cl. CPC C09K 21/02

(57) ABSTRACT

The present disclosure provides a halogen-free inorganic flame retardant material and a preparation method and an application thereof, belonging to the technical field of inorganic liquid flame retardants. The halogen-free inorganic flame retardant material of the present disclosure is prepared by mixing raw materials comprising the following components: an aluminum sulfate aqueous solution, a saturated ferric sulfate aqueous solution and a sodium metasilicate aqueous solution at a volume ratio of 2.5:2.5:1˜2:3:1; the sodium metasilicate aqueous solution and the aluminum sulfate aqueous solution independently has a molar concentration of 0.09˜0.11 mol/L; and the saturated ferric sulfate aqueous solution is a saturated aqueous solution at 15˜17° C. After acting on the surface of combustible materials, various solute components in the raw materials of the halogen-free inorganic flame retardant material of the present disclosure can decompose under high temperature, thus preventing further combustion of the combustible materials.

This application is a National Stage Application of PCT/CN2020/089169, filed May 8, 2020, which claims the benefit of Chinese Patent Application No. 202010222296.7, filed Mar. 26, 2020, and which applications are incorporated herein by reference. To the extent appropriate, a claim of priority is made to each of the above-disclosed applications.

### TECHNICAL FIELD

The present disclosure pertains to the technical field of inorganic liquid flame retardants, and specifically pertains to a halogen-free inorganic flame retardant material and a preparation method and an application thereof.

### BACKGROUND

Flame retardants, also known as fire retardants, are a kind of functional additives which act physically or chemically in a form of solid phase, liquid phase or gas phase (for example, by means of heat-absorption, covering action, inhibition of chain reaction, etc.) in a certain stage of combustion, for example during heating, decomposition, ignition, or the spreading stage of flame and even during the interruption of burning, thus enabling flammable polymers with fire resistance.

Flame retardants can be classified, based on the composition, into halogenated flame retardants (organic chlorides and organic bromides), phosphorus flame retardants (red phosphorus, phosphates and halogenated phosphates, etc.), nitrogen flame retardants, phosphorus-halogenated flame retardants, phosphorus-nitrogen flame retardants and inorganic flame retardants and so on.

At present, the development of flame retardants in China is relatively limited. The main flame retardants in the market are halogenated flame retardants, and the halogenated flame retardants generally include chlorinated paraffin and brominated materials. During application, the halogenated flame retardants will generate hydrogen halide gas with sick smoke under conditions of high temperature and open fire, which would cause suffocation and bring about serious damages to human health and environment. In the preparation process of halogenated flame retardants, they may be decomposed to produce extractable organic compounds, which can accumulate in human body in various ways and thereby cause serious damages to the health and safety of operators. Moreover, the residual attachments of the halogenated flame retardants after fire-retardation are difficult to recycle, thus presenting problems of being adverse to the environment and of low environmental benefits.

### SUMMARY

In view of this, an object of the present disclosure is to provide a halogen-free inorganic flame retardant material and a preparation method and an application thereof. The residual attachments of the halogen-free inorganic flame retardant material of the present disclosure after fire-retardation are easy to recycle, almost having no negative effects on the environment and human health, and the preparation process is safe.

To realize the above object, the present disclosure provides the following technical solutions:

The present disclosure provides a halogen-free inorganic flame retardant material, which is prepared by mixing raw materials comprising the following components:

An aluminum sulfate aqueous solution, a saturated ferric sulfate aqueous solution and a sodium metasilicate aqueous solution at a volume ratio of 2.5:2.5:1˜2:3:1;

The sodium metasilicate aqueous solution has a molar concentration of 0.09˜0.11 mol/L;

The aluminum sulfate aqueous solution has a molar concentration of 0.09˜0.11 mol/L;

The saturated ferric sulfate aqueous solution is a saturated aqueous solution at 15˜17° C.

Preferably, the sodium metasilicate aqueous solution has a molar concentration of 0.1 mol/L.

Preferably, the aluminum sulfate aqueous solution has a molar concentration of 0.1 mol/L.

Preferably, the saturated ferric sulfate aqueous solution is a saturated aqueous solution at 16° C.

Preferably, the volume ratio of the aluminum sulfate aqueous solution, the saturated ferric sulfate aqueous solution and the sodium metasilicate aqueous solution is 2:3:1.

The present disclosure also provides a preparation method of the halogen-free inorganic flame retardant material in the above technical solution, comprising the following steps:

The aluminum sulfate aqueous solution is firstly mixed with the saturated ferric sulfate aqueous solution, and then mixed with the sodium metasilicate aqueous solution, getting the halogen-free inorganic flame retardant material.

The present disclosure also provides an application of the halogen-free inorganic flame retardant material in the above technical solution or the halogen-free inorganic flame retardant material prepared by the preparation method in the above technical solution in the fire-retardation of combustible materials.

The halogen-free inorganic flame retardant material of the present disclosure is prepared by mixing raw materials comprising the following components: an aluminum sulfate aqueous solution, a saturated ferric sulfate aqueous solution and a sodium metasilicate aqueous solution at a volume ratio of 2.5:2.5:1˜2:3:1; the sodium metasilicate aqueous solution has a molar concentration of 0.09˜0.11 mol/L; the aluminum sulfate aqueous solution has a molar concentration of 0.09˜0.11 mol/L; the saturated ferric sulfate aqueous solution is a saturated aqueous solution at 15˜17° C. After acting on the surface of combustible materials, various solute components in the raw materials of the halogen-free inorganic flame retardant material of the present disclosure can decompose under high temperature, ferric oxide is generated from ferric sulfate, aluminum oxide is generated from aluminum sulfate, silicon dioxide and silicon carbide are generated from sodium metasilicate; the resulting materials all cover on the surface of combustible materials, thus preventing further combustion of the combustible materials; at the same time, various solute components in the raw materials absorb heat during decomposition, thus reducing the temperature on the surface of combustible materials and retarding the combustion. In addition, the residual attachments after fire-retardation, including ferric oxide, aluminum oxide, silicon dioxide and silicon carbide, are easy to recycle, almost having no negative effects on the environment and human health. The results of examples show that, the halogen-free inorganic flame retardant material of the present disclosure has good flame retardance properties; paper towels impregnated with an inorganic flame retardant smolder during combustion with little smoke and burn out into char, with a ferric oxide film covering on the surface of combustible materials.

In addition, the preparation method of the present disclosure is simple and highly safe.

### DETAILED DESCRIPTION

The present disclosure provides a halogen-free inorganic flame retardant material, which is prepared by mixing raw materials comprising the following components:

An aluminum sulfate aqueous solution, a saturated ferric sulfate aqueous solution and a sodium metasilicate aqueous solution at a volume ratio of 2.5:2.5:1˜2:3:1; the sodium metasilicate aqueous solution has a molar concentration of 0.09˜0.11 mol/L; the aluminum sulfate aqueous solution has a molar concentration of 0.09˜0.11 mol/L; and the saturated ferric sulfate aqueous solution is a saturated aqueous solution at 15˜17° C.

In the present disclosure, unless otherwise specified, the raw materials used are all conventional commercial products in this field.

In the present disclosure, the sodium metasilicate aqueous solution has a molar concentration of 0.09˜0.11 mol/L, preferably 0.1 mol/L. In the present disclosure, the sodium metasilicate is preferably sodium metasilicate nonahydrate or sodium metasilicate pentahydrate. In the present disclosure, the molar concentration of the sodium metasilicate aqueous solution directly affects the stability and flame retardance properties of the halogen-free inorganic flame retardant material. Too high or too low molar concentration of the sodium metasilicate aqueous solution will deteriorate the stability and flame retardance properties of the halogen-free inorganic flame retardant material. Too high molar concentration of the sodium metasilicate aqueous solution will lead to the increase of pH value of the halogen-free inorganic flame retardant material, thereby breaking the balance of the halogen-free inorganic flame retardant material and making it develop into a suspension; too low molar concentration of the sodium metasilicate aqueous solution will greatly reduce and deteriorate the flame retardance effects of the halogen-free inorganic flame retardant material.

In the present disclosure, the aluminum sulfate aqueous solution has a molar concentration of 0.09˜0.11 mol/L, preferably 0.1 mol/L. In the present disclosure, the aluminum sulfate is preferably aluminum sulfate octadecahydrate. In the present disclosure, the addition of the aluminum sulfate aqueous solution delays the double hydrolysis between sodium metasilicate and ferric sulfate, thus prolonging the shelf life of the halogen-free inorganic flame retardant material. The molar concentration of the aluminum sulfate aqueous solution used in the present disclosure directly affects the flame retardance properties of the halogen-free inorganic flame retardant material; too high or too low molar concentration of the aluminum sulfate aqueous solution will deteriorate the flame retardance effects of the halogen-free inorganic flame retardant material.

In the present disclosure, the saturated ferric sulfate aqueous solution is a saturated aqueous solution at 15˜17° C., preferably a saturated aqueous solution at 16° C. In the present disclosure, the saturated ferric sulfate aqueous solution can suppress smoke and maintain the stable pH of the halogen-free inorganic flame retardant material. If an unsaturated ferric sulfate aqueous solution is employed, the flame retardance effects of the halogen-free inorganic flame retardant material may be deteriorated. In the present disclosure, the method of preparing the saturated ferric sulfate aqueous solution preferably includes the following steps: an excessive amount of ferric sulfate is mixed with water, and the resulting oversaturated aqueous solution is filtered to get the saturated ferric sulfate aqueous solution. The present disclosure has no special limitation on the way of mixing, and any mixing way well known to the persons skilled in the art can be used. In the present disclosure, the filtering temperature is preferably room temperature. In the present disclosure, the filter paper for filtration is preferably the filter paper for laboratory use.

In the present disclosure, the volume ratio of the aluminum sulfate aqueous solution, the saturated ferric sulfate aqueous solution and the sodium metasilicate aqueous solution is 2.5:2.5:1˜2:3:1, preferably 2.3:2.3:1˜2:3:1, more preferably 2:3:1.

After acting on the surface of combustible materials, various solute components (sodium metasilicate, aluminum sulfate and ferric sulfate) in the raw materials of the halogen-free inorganic flame retardant material of the present disclosure can decompose under high temperature, generating ferric oxide, silicon dioxide and silicon carbide, which all cover on the surface of combustible materials, thus preventing further combustion of the combustible materials; at the same time, various solute components in the raw materials absorb heat during decomposition, thus reducing the temperature on the surface of combustible materials and retarding the combustion.

The present disclosure also provides a preparation method of the halogen-free inorganic flame retardant material in the above technical solution, comprising the following steps:

The aluminum sulfate aqueous solution is firstly mixed with the saturated ferric sulfate aqueous solution, and then mixed with the sodium metasilicate aqueous solution, getting the halogen-free inorganic flame retardant material.

In the present disclosure, preferably the aluminum sulfate aqueous solution is firstly mixed with the saturated ferric sulfate aqueous solution until the color of the solution is uniform, and then mixed with the sodium metasilicate aqueous solution, getting the halogen-free inorganic flame retardant material. The present disclosure has no special limitation on specific operations of mixing, as long as mixing the raw materials evenly, particularly stirring for example. In the present disclosure, the circumferential speed of stirring is preferably 0.5 m/s˜1.0 m/s, further preferably 0.8 m/s. In the present disclosure, the sodium metasilicate aqueous solution is a strong alkaline solution. The mixing sequence employed in the present disclosure can ensure the stability of the halogen-free inorganic flame retardant material.

The present disclosure also provides an application of the halogen-free inorganic flame retardant material in the above technical solution or the halogen-free inorganic flame retardant material prepared by the preparation method in the above technical solution in the fire-retardation of combustible materials.

In the present disclosure, the halogen-free inorganic flame retardant material is applied preferably by immersing the combustible materials into the halogen-free inorganic flame retardant material. In the present disclosure, the halogen-free inorganic flame retardant material is preferably suitable for paper materials or wood materials with good permeability. The present disclosure has no special limitation on the amount of the halogen-free inorganic flame retardant material, which can be adjusted according to the actual size of the combustible materials, as long as ensuring the combustible materials completely entering the halogen-free inorganic flame retardant material.

In the present disclosure, the attachments generated from the halogen-free inorganic flame retardant material after fire-retardation include ferric oxide, aluminum oxide, silicon dioxide and silicon carbide. The present disclosure preferably recycles the attachments. In the present disclosure, the recycling method preferably includes the following steps: the attachments are dissolved by mixing with an inorganic acid and filtered for the first time to get the first filtrate and the first filter residue; the first filter residue is mixed with an inorganic base with heating and filtered for the second time to get the second filter residue and the second filtrate, the second filter residue is silicon carbide; the first filtrate is adjusted to pH 5.5˜11.0 with an inorganic base and filtered for the third time to get the third filter residue, the third filter residue includes hydroxides of aluminum and hydroxides of iron; the second filtrate is dissolved by mixing with an inorganic acid and filtered for the fourth time, the resulting fourth filter residue is silicon dioxide. In the present disclosure, the inorganic acid preferably includes hydrochloric acid, sulfuric acid or nitric acid; the molar concentration of the inorganic acid is preferably 0.05 mol/L˜0.2 mol/L. In the present disclosure, the inorganic base is preferably sodium hydroxide or potassium hydroxide; the molar concentration of the inorganic base is preferably 0.05 mol/L˜0.2 mol/L. The present disclosure has no special limitation on the way of mixing, and any mixing way well known to the persons skilled in the art can be used, particularly stirring for example. In the present disclosure, the heating temperature is preferably 50˜85° C. In the present disclosure, the first filtrate is preferably adjusted to pH 5.5˜7.5 and then filtered to get a mixture of hydroxides of aluminum and the filtrate; the resulting filtrate mixture is adjusted to pH 10.0˜11.0 and then filtered to get hydroxides of iron. The halogen-free inorganic flame retardant material as provided in the present disclosure as well as its preparation method and application will be illustrated in detail in combination with the following examples, but they are not construed as the limitation on the protection scope of the present disclosure.

### EXAMPLES 1-3

At 15° C., 14.2 g sodium metasilicate nonahydrate, 20 g ferric sulfate, and 33.3 g aluminum sulfate octadecahydrate were weighed and dissolved in 500 mL water respectively, resulting in a sodium metasilicate aqueous solution of 0.1 mol/L, an aluminum sulfate aqueous solution of 0.1 mol/L and an oversaturated ferric sulfate aqueous solution; the oversaturated ferric sulfate aqueous solution was then filtered to get the saturated ferric sulfate aqueous solution.

The aluminum sulfate aqueous solution was firstly mixed with the saturated ferric sulfate aqueous solution, and then mixed with the sodium metasilicate aqueous solution, getting the halogen-free inorganic flame retardant material, of which the specific composition was shown in Table 1.

Paper towels of the same sizes were partially immersed in different formulated halogen-free inorganic flame retardant materials respectively, where the immersion period was 3 s, and the immersion depth was 1 cm; then taken out and dried by baking on an asbestos wire gauze heated with an alcohol lamp; the ends of the paper towels which were not immersed were ignited vertically to observe the specific phenomena of combustion and assess the flame retardance effects.

The flame retardance effects of the halogen-free inorganic flame retardant materials are shown in Table 1, and the volumes of different halogen-free inorganic flame retardant materials are all 30 mL.

TABLE 1
Flame retardance effects of halogen-free inorganic flame
retardant materials of different compositions

| | Volume ratio of the aluminum | | |
|---|---|---|---|
| | sulfate aqueous solution, the | | |
| | saturated ferric sulfate aqueous | | |
| | solution and the sodium | | |
| Examples | metasilicate aqueous solution | Liquid observation | Ignition effects |
| 1 | 10:15:5 | Dark orange clear | Char-forming after 190 s, |
| | | solution, with good | smoldering, little smoke, |
| | | immersion effects | with a ferric oxide film |
| | | | covering on the surface |
| 2 | 12:13:5 | Orange-red clear | Char-forming after 137 s, |
| | | solution, with good | smoldering, less smoke |
| | | immersion effects | |
| 3 | 11:14:5 | Orange-red clear | Char-forming after 148 s, |
| | | solution, with good | smoldering, less smoke |
| | | immersion effects | |

It can be known from analysis of the experimental results in Table 1 that, the halogen-free inorganic flame retardant material of the present disclosure has good flame retardance properties; paper towels smoldered during combustion with little smoke and turned into char when burnt out, an oxide film was formed covering the surface, and the color of the oxide film was red-brown. After taking down the oxide film, it was found that the oxide film was soluble in a sulfuric acid solution to form a yellow solution, which was calcined under high temperature to get black solid, confirming that the oxide film was ferric oxide film.

The attachments on the surface of the combustible materials after combustion in Example 1 were sampled, and dissolved by mixing with 0.2 mol/L of sulfuric acid and filtered to get the first filtrate and the first filter residue, where the first filtrate included iron ions and aluminum ions; the first filter residue was mixed with 1 mol/L of sodium hydroxide solution and dissolved at 80° C., then filtered to get silicon carbide powders and the second filtrate;

The first filtrate was mixed with 0.2 mol/L of sodium hydroxide solution to adjust the first filtrate to pH 6.0, and then filtered to get a mixture of aluminum hydroxide and the filtrate. The filtrate mixture was mixed with 0.2 mol/L of sodium hydroxide solution to adjust the filtrate mixture to pH 10.0, and then filtered to get ferric hydroxide.

The second filtrate was mixed with 1 mol/L of sulfuric acid and then filtered to get silicon dioxide, thus finally achieving the separation.

### COMPARATIVE EXAMPLES 1-5

14.2 g sodium metasilicate nonahydrate, 20 g ferric sulfate, and 33.3 g aluminum sulfate octadecahydrate were weighed and dissolved in 500 mL water respectively, resulting in a sodium metasilicate aqueous solution of 0.1 mol/L, an aluminum sulfate aqueous solution of 0.1 mol/L and an oversaturated ferric sulfate aqueous solution; the oversaturated ferric sulfate aqueous solution was then filtered to get the saturated ferric sulfate aqueous solution.

The aluminum sulfate aqueous solution was firstly mixed with the saturated ferric sulfate aqueous solution, and then mixed with the sodium metasilicate aqueous solution, getting the halogen-free inorganic flame retardant material, of which the specific composition was shown in Table 2.

Paper towels of the same sizes and materials as those in Example 1 were partially immersed in different formulated halogen-free inorganic flame retardant materials respectively, where the immersion period was 3 s, and the immersion depth was 1 cm; then taken out and dried by baking on an asbestos wire gauze heated with an alcohol lamp; the ends of the paper towels which were not immersed were ignited vertically to observe the specific phenomena of combustion and assess the flame retardance effects.

The flame retardance effects of the halogen-free inorganic flame retardant materials are shown in Table 2, and the volumes of different halogen-free inorganic flame retardant materials are all 30 mL.

TABLE 2
Flame retardance effects of halogen-free inorganic flame
retardant materials of different compositions

| | Volume ratio of the aluminum | | |
|---|---|---|---|
| | sulfate aqueous solution, the | | |
| | saturated ferric sulfate aqueous | | |
| Comparative | solution and the sodium metasilicate | | |
| examples | aqueous solution | Liquid observation | Ignition effects |
| 1 | 0:25:5 | Dark orange-red | Burnt out within 8 s, |
| | | clear solution, with | with flames, no obvious |
| | | good immersion | flame retardance effects |
| | | effects | |
| 2 | 25:0:5 | Colorless clear | Burnt out within 8 s, |
| | | solution, with good | with flames, no obvious |
| | | immersion effects | flame retardance effects |
| 3 | 15:15:0 | Light-yellow clear | Burnt out within 36 s, |
| | | solution, with good | with flames, capable of |
| | | immersion effects | forming char, medium |
| | | | smoke |
| 4 | 12:18:0 | Yellow clear | Burnt out within 59 s, |
| | | solution, with good | smoldering, capable of |
| | | immersion effects | forming char, little |
| | | | smoke |
| 5 | 18:12:0 | Yellowish clear | All turning into char |
| | | solution, with good | within 57 s, |
| | | immersion effects | smoldering, large |
| | | | smoke |

It can be known form the above experimental data analysis that, lack of any one component in the halogen-free inorganic flame retardant material will produce great influences on the flame retardance effects, that is, deteriorating the flame retardance properties of the flame retardant material.

### COMPARATIVE EXAMPLE 6

At 15° C., 14.2 g sodium metasilicate nonahydrate, 20 g ferric sulfate, and 66.6 g aluminum sulfate octadecahydrate were weighed and dissolved in 500 mL water respectively, resulting in a sodium metasilicate aqueous solution of 0.1 mol/L, an aluminum sulfate aqueous solution of 0.2 mol/L and an oversaturated ferric sulfate aqueous solution; the oversaturated ferric sulfate aqueous solution was then filtered to get the saturated ferric sulfate aqueous solution.

10 mL of the aluminum sulfate aqueous solution was firstly mixed with 15 mL of the saturated ferric sulfate aqueous solution, and then mixed with 5 mL of the sodium metasilicate aqueous solution, getting the halogen-free inorganic flame retardant material.

Paper towels of the same sizes as those in Example 1 were partially immersed in different formulated halogen-free inorganic flame retardant materials respectively, where the immersion period was 3 s, and the immersion depth was 1 cm; then taken out and dried by baking on an asbestos wire gauze heated with an alcohol lamp; the ends of the paper towels which were not immersed were ignited vertically to observe the specific phenomena of combustion and assess the flame retardance effects.

The flame retardance effects of the halogen-free inorganic flame retardant material are shown in Table 3.

### COMPARATIVE EXAMPLE 7

At 15° C., 28.4 g sodium metasilicate nonahydrate, 20 g ferric sulfate, and 33.3 g aluminum sulfate octadecahydrate were weighed and dissolved in 500 mL water respectively, resulting in a sodium metasilicate aqueous solution of 0.2 mol/L, an aluminum sulfate aqueous solution of 0.1 mol/L and a saturated ferric sulfate aqueous solution.

10 mL of the aluminum sulfate aqueous solution was firstly mixed with 15 mL of the saturated ferric sulfate aqueous solution, and then mixed with 5 mL of the sodium metasilicate aqueous solution, getting the halogen-free inorganic flame retardant material.

Paper towels of the same sizes as those in Example 1 were partially immersed in different formulated halogen-free inorganic flame retardant materials respectively, where the immersion period was 3 s, and the immersion depth was 1 cm; then taken out and dried by baking on an asbestos wire gauze heated with an alcohol lamp; the ends of the paper towels which were not immersed were ignited vertically to observe the specific phenomena of combustion and assess the flame retardance effects.

The flame retardance effects of the halogen-free inorganic flame retardant material are shown in Table 3.

### COMPARATIVE EXAMPLE 8

At 15° C., 14.2 g sodium metasilicate nonahydrate, 10 g ferric sulfate, and 33.3 g aluminum sulfate octadecahydrate were weighed and dissolved in 500 mL water respectively, resulting in a sodium metasilicate aqueous solution of 0.1 mol/L, an aluminum sulfate aqueous solution of 0.1 mol/L and an ferric sulfate aqueous solution of 0.0125 mol/L.

10 mL of the aluminum sulfate aqueous solution was firstly mixed with 15 mL of the ferric sulfate aqueous solution, and then mixed with 5 mL of the sodium metasilicate aqueous solution, getting the halogen-free inorganic flame retardant material.

Paper towels of the same sizes as those in Example 1 were partially immersed in different formulated halogen-free inorganic flame retardant materials respectively, where the immersion period was 3 s, and the immersion depth was 1 cm; then taken out and dried by baking on an asbestos wire gauze heated with an alcohol lamp; the ends of the paper towels which were not immersed were ignited vertically to observe the specific phenomena of combustion and assess the flame retardance effects.

The flame retardance effects of the halogen-free inorganic flame retardant materials are shown in Table 3.

TABLE 3
Flame retardance effects of the halogen-free inorganic flame
retardant materials in Example 1 and comparative examples 6~8

| | Liquid observation | Ignition effects |
|---|---|---|
| Example 1 | Darker orange clear solution, | Char-forming after 190 s, |
| | with good immersion effects | smoldering, little smoke, |
| | | with a ferric oxide film |
| | | covering the surface |
| Comparative example 6 | Lighter orange solution, with | Char-forming after 85 s, |
| | good immersion effects | smoldering, medium smoke |
| Comparative example 7 | Yellow suspension, with | Char-forming after 40 s, |
| | poor immersion effects | smoldering, large smoke |
| Comparative example 8 | Light yellow solution, with | Char-forming after 65 s, |
| | good immersion effects | smoldering, little smoke |

It can be known from the above experimental results that, the concentration of any one component in the halogen-free inorganic flame retardant material will produce great influences on the flame retardance effects, that is, deteriorating the flame retardance properties of the flame retardant material.

The foregoing is only preferable implementation of the present disclosure. It should be noted to persons with ordinary skills in the art that several improvements and modifications can be made without deviating from the principle of the present disclosure, which are also considered as the protection scope of the present disclosure.

1. A halogen-free inorganic flame retardant material, wherein, it is prepared by mixing raw materials comprising the following components:
an aluminum sulfate aqueous solution, a saturated ferric sulfate aqueous solution and a sodium metasilicate aqueous solution at a volume ratio of 2.5:2.5:1˜2:3:1;
wherein the sodium metasilicate aqueous solution has a molar concentration of 0.09˜0.11 mol/L;
the aluminum sulfate aqueous solution has a molar concentration of 0.09˜0.11 mol/L; and
the saturated ferric sulfate aqueous solution is a saturated aqueous solution at 15˜17° C.

2. The halogen-free inorganic flame retardant material according to claim 1, wherein, the sodium metasilicate aqueous solution has a molar concentration of 0.01 mol/L.

3. The halogen-free inorganic flame retardant material according to claim 1, wherein, the aluminum sulfate aqueous solution has a molar concentration of 0.01 mol/L.

4. The halogen-free inorganic flame retardant material according to claim 1, wherein, the saturated ferric sulfate aqueous solution is a saturated aqueous solution at 16° C.

5. The halogen-free inorganic flame retardant material according to claim 1, wherein, the volume ratio of the aluminum sulfate aqueous solution, the saturated ferric sulfate aqueous solution and the sodium metasilicate aqueous solution is 2:3:1.

6. A preparation method of the halogen-free inorganic flame retardant material according to claim 1, wherein, comprising the following steps:
the aluminum sulfate aqueous solution is firstly mixed with the saturated ferric sulfate aqueous solution, and then mixed with the sodium metasilicate aqueous solution, getting the halogen-free inorganic flame retardant material.

7. A method of flame retardant for combustibles, wherein, using the halogen-free inorganic flame retardant material according to claim 1.

8. The preparation method of the halogen-free inorganic flame retardant material according to claim 6, wherein, the sodium metasilicate aqueous solution has a molar concentration of 0.01 mol/L.

9. The preparation method of the halogen-free inorganic flame retardant material according to claim 6, wherein, the aluminum sulfate aqueous solution has a molar concentration of 0.01 mol/L.

10. The preparation method of the halogen-free inorganic flame retardant material according to claim 6, wherein, the saturated ferric sulfate aqueous solution is a saturated aqueous solution at 16° C.

11. The preparation method of the halogen-free inorganic flame retardant material according to claim 6, wherein, the volume ratio of the aluminum sulfate aqueous solution, the saturated ferric sulfate aqueous solution and the sodium metasilicate aqueous solution is 2:3:1.

12. The method of flame retardant for combustibles according to claim 7, wherein, the sodium metasilicate aqueous solution has a molar concentration of 0.01 mol/L.

13. The method of flame retardant for combustibles according to claim 7, wherein, the aluminum sulfate aqueous solution has a molar concentration of 0.01 mol/L.

14. The method of flame retardant for combustibles according to claim 7, wherein, the saturated ferric sulfate aqueous solution is a saturated aqueous solution at 16° C.

15. The method of flame retardant for combustibles according to claim 7, wherein, the volume ratio of the aluminum sulfate aqueous solution, the saturated ferric sulfate aqueous solution and the sodium metasilicate aqueous solution is 2:3:1.
